(19) United States
(12) Patent Application Publication
(10) Pub. No.: US 2011/0139572 A1
(43) Pub. Date: Jun. 16, 2011

(54) Method For Manufacturing Steel Plate-Shaped Component, Pole Parking, And Cold Forging Die

(75) Inventors: Hitoshi Nomasa, Toyota-shi (JP); Hiroki Uba, Toyota-shi (JP); Yoshinori Morita, Toyota-shi (JP); Ryuji Ibaraki, Toyota-shi (JP); Koichi Kondo, Toyota-shi (JP); Masahiro Kojima, Toyota-shi (JP); Fuminori Ashikawa, Higashimatsuyama-shi (JP); Tsugio Saito, Higashimatsuyama-shi (JP)

(73) Assignees: TOSHIMA MANUFACTURING CO., LTD., Saitama (JP); TOYOTA JIDOSHA KABUSHIKI KAISHA, Aichi-ken (JP)

(21) Appl. No.: 12/939,648

(22) Filed: Nov. 4, 2010

(30) Foreign Application Priority Data
Nov. 6, 2009 (JP) 2009-255047

(51) Int. Cl. F16H 61/22; B21J 5/02; B21J 13/02

(52) U.S. Cl. 192/219.5; 72/352; 72/356; 72/470

(57) ABSTRACT

The present invention provides a method for manufacturing a steel plate-shaped component which can increase the yield and the working efficiency. When a steel plate-shaped component (1) such as a pole parking is manufactured, a steel disk-shaped initial material (10) is vertically placed in a cavity (41) of a dice (40) of a cold forging die so that the thickness direction of the initial material (10) is perpendicular to a pressing direction. The initial material (10) is pressed through cold forging against the peripheral side portion (11) by a punch (42) while the initial thickness of the initial material (10) is maintained substantially as it is, whereby an approximate component (20) approximating the plate-shaped component (1) is obtained. Subsequently, a margin portion (25) of the approximate component (20) is removed, whereby a half-finished product (30) is obtained. The half-finished product (30) is subjected to cutting work, carburizing processing, and so on, whereby the plate-shaped component (1) is obtained.

### BACKGROUND OF THE INVENTION

1. Field of the Invention

The present invention relates to a method for manufacturing a steel plate-shaped component, a pole parking (also called a parking pole), and a cold forging die, and more specifically relates to a method for manufacturing a steel plate-shaped component such as a pole parking, which is used in a parking lock device for an automatic transmission for vehicles, by cold forging pressing, a pole parking obtained by the method, and a cold forging die used in the method.

2. Background Art

A pole parking used in a parking lock device for an automatic transmission for vehicles is a well-known plate-shaped component. A pole parking has a thickness of about 10 mm and is formed of, for example, chrome steel. FIG. 1 is a plan view of a pole parking. The pole parking 1 is a nearly L-shaped arm body 1, which can rotate around a shaft hole 2 receiving a supporting shaft (not shown) through the hole. The arm body 1 has an arm proximal portion 1a on the shaft hole 2 side, an arm distal portion 1b on the side away from the shaft hole 2, and a engagement projection 3 protruding downward on FIG. 1 (Up, down, left, right, etc. denoting directions are relative) at the middle between the arm proximal portion 1a and the arm distal portion 1b. When a vehicle with an automatic transmission is parked, a shift lever is put in “P (parking)”, so that the arm body 1 rotates in the counter clockwise direction against the biasing of an elastic element such as a torsion coil spring, and the engagement projection 3 engages with a parking gear (not shown) which is connected to an axle of the vehicle, whereby the vehicle is brought into a parking lock state. In the pole parking 1, the engagement projection 3 is especially required to have high strength and accuracy.

Plate-shaped components such as a pole parking which are required to have high strength and accuracy have been manufactured by a fine blanking process, hot forging, cold forging, and so on. In the fine blanking process, one or more plate-shaped components are punched out from a plate material with high accuracy. In this case, there would be generated a large quantity of unnecessary portions from the plate material, which reduces the yield, and there is also a problem that a press machine for fine blanking is very expensive. In the case of hot forging, in general, a round bar material is pressed into a plate-shaped material, and then the plate-shaped material is subjected to cutting and so on. However, since a decarburized layer arises at a depth of approximately 0.8 to 1.0 mm from the surface of the plate-shaped material, carburizing processing is required to be performed after removal of the decarburized layer. Consequently, the yield reduces, the number of manufacturing steps increases, and the working efficiency reduces.

When a plate-shaped component is manufactured by cold forging, in general, a round bar-shaped raw material is cut to a columnar material, and the columnar material is placed in a cold forging die. The columnar material is then pressed from on one circular surface thereof to be a shape close to its final shape while the thickness (height) of the columnar material between the one circular surface and the opposite circular surface is reduced. However, if this manufacturing way is applied to the manufacturing of a pole parking, a large pressing force is required, and in forming the shape of the columnar material to be close to the shape of a final pole parking, the columnar material receives an excessive force, which reduces the durability of the die. In order to avoid this problem, it would be possible to have included, from the beginning, a relatively large margin portion in the columnar material which should be removed later, yet in this case, the yield also lowers.

Japanese Patent Application Laid-Open No. 7-236930 discloses an example of a method for manufacturing a pole parking adopting cold forging. In the manufacturing method, a steel bar material is cut to a predetermined length to be squeezed and then to be bent. Thereafter, the bar material is formed in a cold forging die and then finished. However, in this method, since the squeezing and bending steps should be performed before cold forging pressing, the number of steps is large, and the working efficiency is low.

### SUMMARY OF THE INVENTION

In view of the above problems, the present invention provides a method for manufacturing a steel plate-shaped component, which can increase the yield and the working efficiency, a pole parking obtained by the method, and a cold forging die used in the method.

In order to solve the above problem, the present invention provides a method for manufacturing a steel plate-shaped component. The method includes a first step of placing a steel plate-shaped initial material in a cold forging die, the initial material having front and rear surfaces parallel to each other and a peripheral side portion between the outer circumference of the front surface and the outer circumference of the rear surface, where, in the cold forging die, the thickness direction between the front and rear surfaces of the initial material is perpendicular to a pressing direction, and a second step of, while maintaining the initial thickness of the initial material substantially as it is (the initial thickness of the initial material might be slightly increased by cold forging pressing), pressing the initial material against the peripheral side portion of the initial material and then cold forging deforming the initial material to an approximate component which has a shape approximating (very close to) the shape of the plate-shaped component.

In the present invention, the steel plate-shaped initial material is subjected to cold forging by pressing against the peripheral side portion of the initial material from the direction perpendicular to the thickness direction of the initial material, while maintaining the initial thickness of the initial material substantially as it is, whereby the approximate component is formed. Thus, the weight and volume are set to be the same as those of the approximate component, and the initial thickness of the initial material is set to be substantially the same as that of the approximate component and that of the finally produced plate-shaped component. The initial thickness of the initial material might be slightly increased through cold forging pressing to be the approximate component.

In the present invention, although the initial material may have a disk shape, the shape is not limited thereto, and the initial material may be a plate having a rectangular, polygonal, or oval shape.

The method for manufacturing a steel plate-shaped component of the present invention may include a third step of finishing the approximate component obtained in the second step to the plate-shaped component.

In one embodiment of the present invention, the third step includes a punching step of punching out an unnecessary margin (a margin portion) at a peripheral edge portion of the approximate component. The margin is set to be as small as possible, and, in the present invention, the margin portion may be set to be not more than about 30%.

In one embodiment of the present invention, the third step includes a step of performing carburizing processing after the punching step. By virtue of the carburizing processing, a desired surface hardness is obtained.

In one embodiment of the present invention, the disk-shaped component is a pole parking used in a parking lock device for an automatic transmission for vehicles.

Another invention of the present invention provides a pole parking used in a parking lock device for an automatic transmission for vehicles. The pole parking is obtained by Placing a steel disk-shaped initial material in a cold forging die, the initial material having front and rear surfaces parallel to each other and a peripheral side portion between the outer circumference of the front surface and the outer circumference of the rear surface, where, in a cold forging die, the thickness direction between the front and rear surfaces is perpendicular to a pressing direction; while maintaining the initial thickness of the initial material substantially as it is, pressing the initial material against the peripheral side portion of the initial material and then cold forging deforming the initial material to an approximate component which has a shape approximating the pole parking; and finishing the approximate component to the pole parking.

A further invention of the present invention provides a cold forging die used in the method for manufacturing a steel plate-shaped component. The cold forging die comprises a dice and a punch. The dice has a cavity having an interval corresponding to the initial thickness of the initial material with the thickness direction of the cavity is perpendicular to the pressing direction. The punch is moved downward to the cavity in order to press the initial material against its peripheral side portion.

In the cold forging die, the cavity and the punch have their respective bottom portions. Each of the bottom portions has an outline corresponding to the outline of the approximate component.

In the present invention, a plate-shaped initial material is subjected to cold forging by pressing against the peripheral side portion thereof while the initial thickness of the initial material is maintained substantially as it is, whereby an approximate component approximating the plate-shaped component as a final product can be obtained. Therefore, in comparison with the prior manufacturing method, the yield is improved, and the number of processes is reduced, whereby the working efficiency can be improved.

### BRIEF DESCRIPTION OF THE DRAWINGS

FIG. 1 is a plan view of a pole parking;

FIG. 2 is a plan view of an initial material;

FIG. 3 is a side view of the initial material;

FIG. 4 is a front explanatory view showing an initial stage of a cold forging press process;

FIG. 5 is a partial side cross-sectional view of a cold forging die along line A-A of FIG. 4;

FIG. 6 is a perspective view of the cold forging die;

FIG. 7 is a front explanatory view showing an intermediate stage of the cold forging press process;

FIG. 8 is a front explanatory view showing a final stage of the cold forging press process;

FIG. 9 is a plan view of an approximate component; and

FIG. 10 is a plan view of a half-finished product.

### BEST MODE FOR CARRYING OUT THE INVENTION

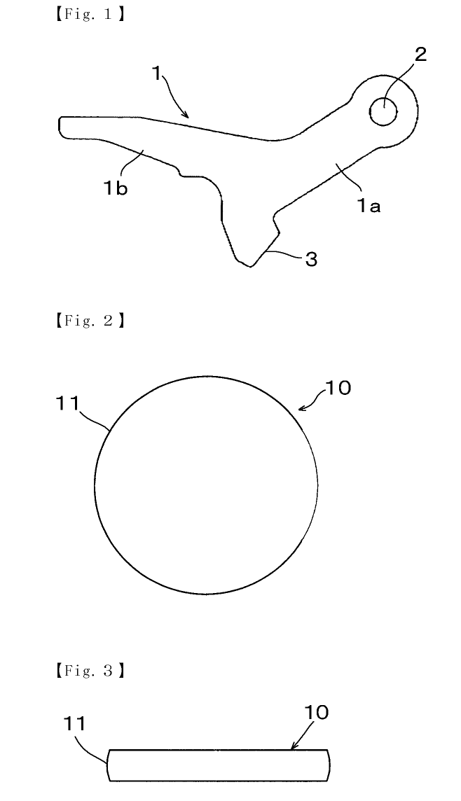

Hereinafter, the preferred embodiment of the present invention will be described with reference to the drawings. In this embodiment, a pole parking 1 (FIG. 1) used in a parking lock device for an automatic transmission for vehicles is described as an example of a plate-shaped component.

In the manufacturing of the pole parking 1, first, a round bar-shaped raw material (not shown) of chrome steel is cut to a columnar material (not shown). Then, the columnar material is compressed by a press machine or the like to be a disk-shaped initial material 10 as shown in FIGS. 2 and 3. Alternatively, a plurality of initial materials 10 (or columnar materials) may be punched out from a plate-shaped raw material. The initial material 10 (or the columnar material) has front and rear surfaces parallel to each other and a peripheral side surface 11 defined between the outer circumference of the front surface and the outer circumference of the rear surface. The weight and volume of the initial material 10 are set to be the same as those of an approximate component 20 to be described later. The thickness (initial thickness) of the initial material 10 (the interval between the front and rear surfaces) is set to be substantially the same as the thickness of the approximate component 20 and the completed pole parking 1. However, technically, in consideration of a slight expansion in the thickness direction in the cold forging pressing to be described later, the thickness of the initial material 10 can be set to be slightly smaller than the thickness of the approximate component 20 (and the pole parking 1).

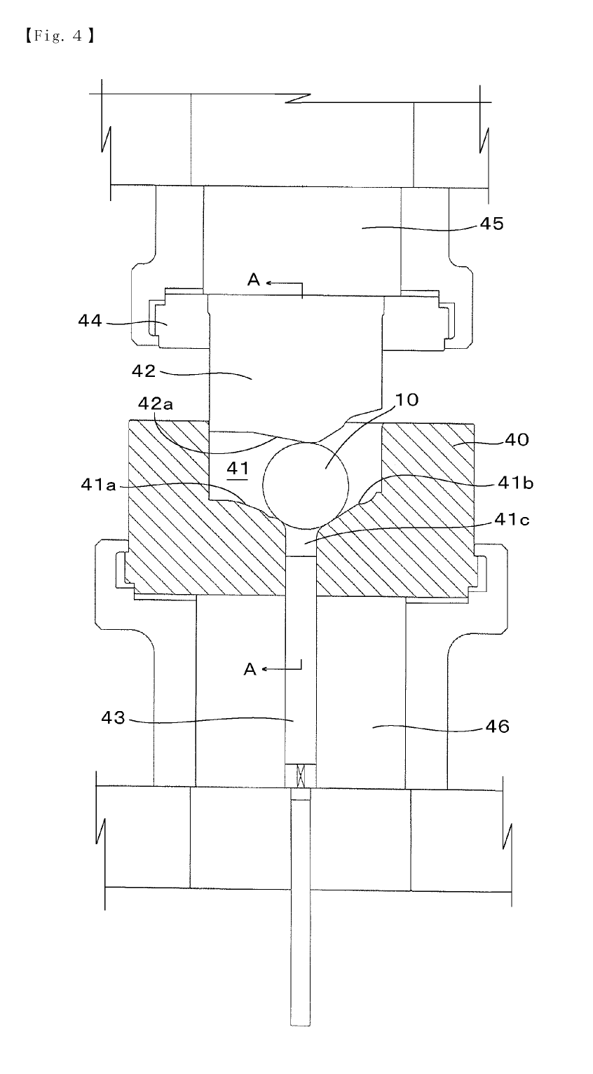

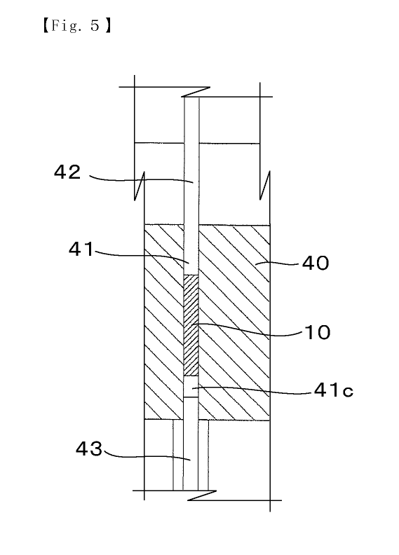

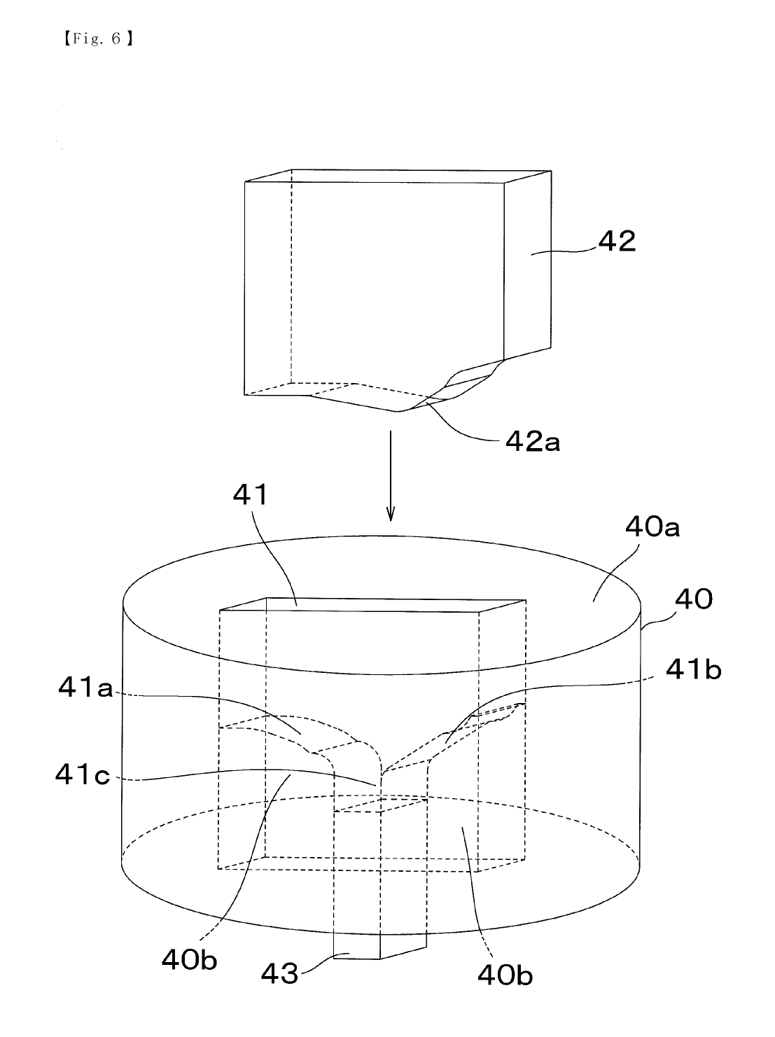

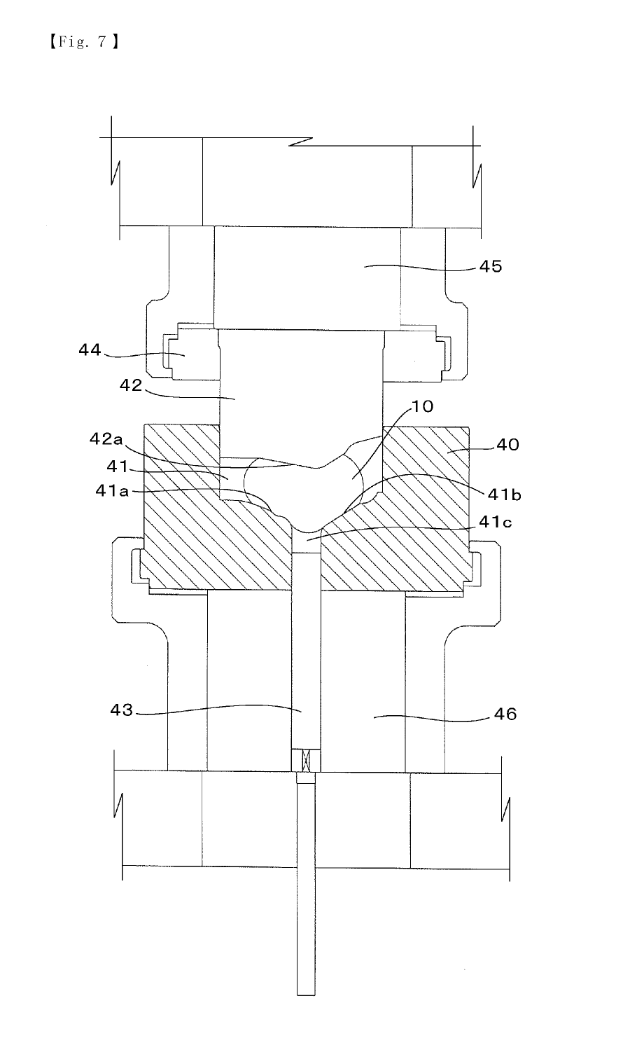

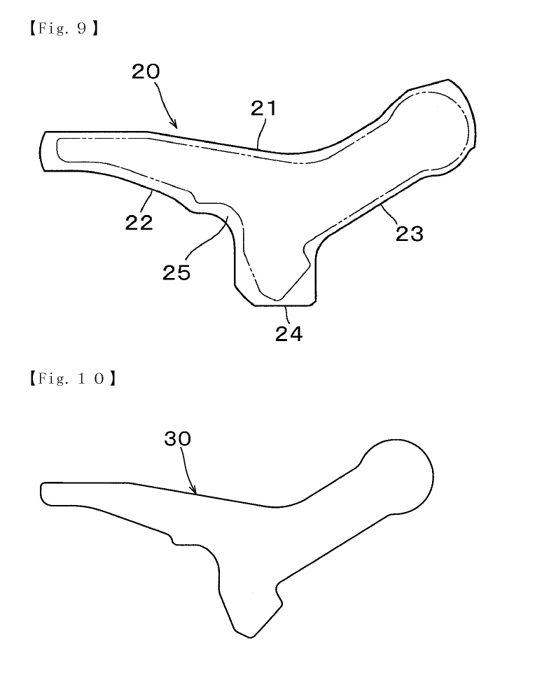

Next, the initial material 10 is subjected to cold forging with a cold forging die set in a press machine as shown in FIG. 4. The cold forging die comprises a dice 40 having a cavity 41 and a plate-shaped punch 42. The initial material 10 is stored or placed in the cavity 41 of the dice 40. As shown in FIGS. 5 and 6, the cavity 41 is open on the upper surface of the dice 40, and has an interval corresponding to the thickness of the initial material 10 in the front-back directions based on FIG. 4 (the thickness direction of the initial material 10). Thus, the initial material 10 is set in the cavity 41 only in a state of being vertically placed with the front and rear surfaces of the circular disk (initial material) being in the vertical (up and down) directions (the pressing direction), and the thickness direction of the initial material 10 is perpendicular to the pressing direction. A bottom portion (41a and 41b) of the cavity 41 has an outline corresponding to that of the approximate component 20, and a bottom portion 42a of the punch 42 has also an outline corresponding to that of the approximate component 20. The outline of the approximate component 20 has been obtained by previous computer analysis and trials. Namely, the bottom portion 42a of the punch 42 has a shape corresponding to the upper side portion 21 (See FIG. 9) of the approximate component 20 approximating the upper side portion of the pole parking (arm body) 1 (See FIG. 1). In the cavity 41, a left bottom portion 41a and a right bottom portion 41b are provided, and a clearance 41c is provided at a bottom portion between the left and right bottom portions 41a and 41b. The left bottom portion 41a has a shape corresponding to a lower left side portion 22 (See FIG. 9) of the approximate component 20 approximating an arm distal portion 1b of the pole parking 1, and the right bottom portion 41b has a shape corresponding to a lower right side portion 23 (See FIG. 9) of the approximate component 20 approximating an arm proximal portion 1a of the pole parking 1. The clearance 41c is used for forming a shape corresponding to a lower intermediate projection 24 of the approximate component 20 approximating an engagement projection 3 of the pole parking 1. As seen from FIG. 6, the dice 40 is separated into a columnar body or a cylindrical body 40a and left and right inserts 40b. The cylindrical body 40a includes a vertically plate-shaped space corresponding to the cavity 41, namely, a cavity space. The two inserts 40b are inserted from below into the cavity space of the body 40a defining the left and right bottom portions 41a and 41b. In FIG. 4 and so on, the reference numeral 43 denotes a knockout disposed below the clearance 41c, the reference numeral 44 denotes a punch holder holding the punch 42, and the reference numerals 45 and 46 denote upper and lower pressure plates.

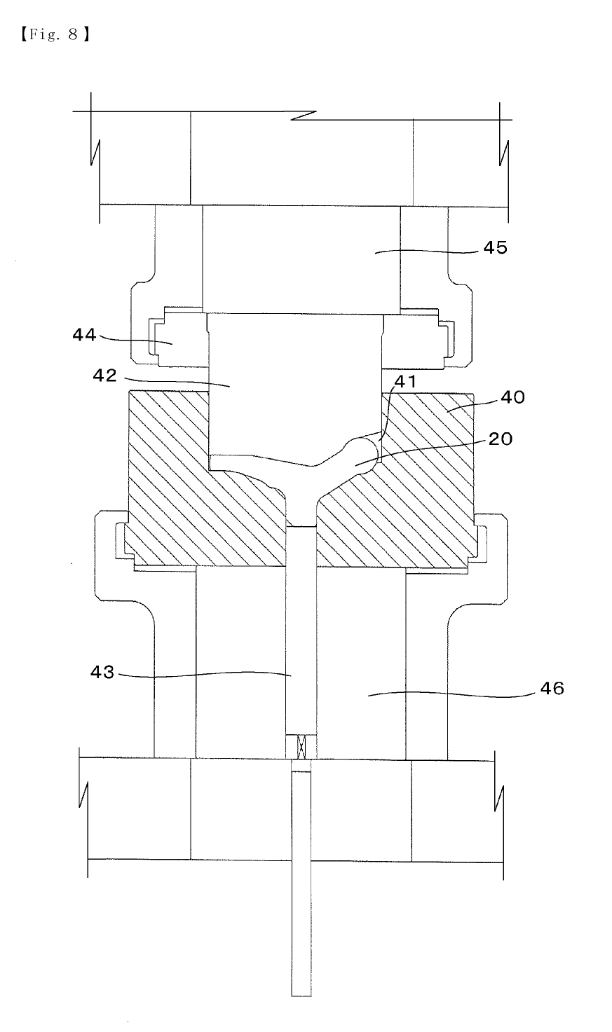

BY operating the press machine to move the punch 42 downward, the initial material 10, from the initial state in FIG. 4, receives a pressing force on the peripheral side surface 11 (See FIG. 3) between the punch 42 and the dice 40. Then, the initial material (circular disk) 10 is plastically deformed only in the radial direction of the disk inward and outward through cold forging while a deformation of the initial material 10 in the thickness direction is limited. The intermediate state and the final state of the radial deformation are shown in FIGS. 7 and 8, respectively. As seen from those Figs., during the deformation, the initial material 10 extends to the left side and the right side while vertically collapsing between the bottom portion 42a of the punch 42 and the left and right bottom portions 41a and 41b of the cavity 41 of the dice 40, projecting into the clearance 41c downward.

By virtue of the cold forging pressing, the approximate component 20 as shown in FIG. 9 is obtained. Subsequently, an unnecessary margin (a margin portion) 25 (about 27% of the approximate component 20) at the peripheral edge portion of the approximate component 20 is punched out by a press, whereby a half-finished product 30 in FIG. 10 is obtained. The margin 25 can be removed by not only punching but also cutting, for example. The margin 25 is set to be as small as possible. In this example, although the margin 25 extends around the entire peripheral edge of the approximate component 20, there is a case that an necessary margin (25) extends over a part of the peripheral edge of the component 20. In the latter case, the remaining peripheral edge is used as it is as a part of the peripheral edge of the half-finished product 30. In the removal of the unnecessary margin 25, the lower intermediate projection 24 of the approximate component 20 is required to have the highest dimension accuracy since the lower intermediate projection 24 is to be the engagement projection 3 of the pole parking 1. On the other hand, the upper side portion 21 and so on of the approximate component 20 are not required to have high accuracy relative to the lower intermediate projection 24. Subsequently, the half-finished product 30 is subjected to cutting work and then is subjected to carburizing processing. Thereafter, a shaft hole 2 is formed in the half-finished product 30, whereby the pole parking 1 is completed.

As described above, in the present embodiment, the approximate component 20 can be obtained from the disk-shaped initial material 10 at once by the cold forging pressing, and therefore, the number of manufacturing steps reduces, and the working efficiency improves. Further, since the margin which should be removed from the approximate component 20 is small, the yield is very high. Furthermore, since the peripheral side surface 11 of the initial material 10 is pressed from the direction perpendicular to the thickness direction of the disk-shaped initial material 10, a pressing force can be significantly reduced in comparison with cold forging in which a pressing force is applied onto a front (or rear) surface of a disk-shaped material. Although, in the foregoing description, the initial material 10 has a disk shape, it may have a rectangular shape or other shapes.

### EXPLANATION OF REFERENCE NUMERALS

1 Pole parking (arm body)
10 Initial material
20 Approximate component
25 Unnecessary margin at peripheral edge portion of the approximate component
30 Half-finished product
40 Dice
41 Cavity
41a Left bottom portion of the cavity
41b Right bottom portion of the cavity
41c Clearance
42 Punch
42a Bottom portion of the punch

1. A method for manufacturing a steel plate-shaped component, comprising:
a first step of placing a steel plate-shaped initial material in a cold forging die, the initial material having front and rear surfaces parallel to each other and a peripheral side portion between the outer circumference of the front surface and the outer circumference of the rear surface, where, in the cold forging die, the thickness direction between the front and rear surfaces of the initial material is perpendicular to a pressing direction; and
a second step of, while maintaining the initial thickness of the initial material substantially as it is, pressing the initial material against the peripheral side portion of the initial material and then cold forging deforming the initial material to an approximate component which has a shape approximating the shape of the plate-shaped component.

2. The method for manufacturing a steel plate-shaped component according to claim 1, further comprising a third step of finishing the approximate component obtained in the second step to the plate-shaped component.

3. The method for manufacturing a steel plate-shaped component according to claim 2, wherein the third step comprises a punching step of punching out an unnecessary margin at a peripheral edge portion of the approximate component.

4. The method for manufacturing a steel plate-shaped component according to claim 3, wherein the third step comprises a step of performing carburizing processing after the punching step.

5. The method for manufacturing a steel plate-shaped component according to any one of claims 1 to 4, wherein the initial material has a disk shape.

6. The method for manufacturing a steel plate-shaped component according to claim 1, wherein the disk-shaped component is a pole parking used in a parking lock device for an automatic transmission for vehicles.

7. A pole parking used in a parking lock device for an automatic transmission for vehicles, which is obtained by placing a steel disk-shaped initial material in a cold forging die, the initial material having front and rear surfaces parallel to each other and a peripheral side portion between the outer circumference of the front surface and the outer circumference of the rear surface, where, in a cold forging die, the thickness direction between the front and rear surfaces of the initial material is perpendicular to a pressing direction; while maintaining the initial thickness of the initial material substantially as it is, pressing the initial material against the peripheral side portion of the initial material and then cold forging deforming the initial material to an approximate component which has a shape approximating the pole parking; and finishing the approximate component to the pole parking.

8. A cold forging die used in the method for manufacturing a steel plate-shaped component according to claim 1, comprising:
a dice which has a cavity having an interval corresponding to the initial thickness of the initial material with the thickness direction of the cavity is perpendicular to the pressing direction; and
a punch which is moved downward to the cavity in order to press the initial material.

9. The cold forging die according to claim 8, wherein the cavity
and the punch have their respective bottom portions, each of which has an outline corresponding to that of the approximate component.
